(19) United States
(12) Patent Application Publication
(10) Pub. No.: US 2016/0378656 A1
(43) Pub. Date: Dec. 29, 2016

(54) STORAGE DEVICE, CACHE-WRITE CONTROL METHOD, AND CACHE-WRITE CONTROL PROGRAM

(71) Applicant: FUJITSU LIMITED, Kawasaki-shi (JP)

(72) Inventor: SATOMI KUDO, Kahoku (JP)

(73) Assignee: FUJITSU LIMITED, Kawasaki-shi (JP)

(21) Appl. No.: 15/139,389

(22) Filed: Apr. 27, 2016

(30) Foreign Application Priority Data
Jun. 24, 2015 (JP) 2015-126942

(51) Int. Cl. G06F 12/08

(52) U.S. Cl. CPC G06F 12/0815; G06F 2212/1032

(57) ABSTRACT

When write data is written in part of a write unit area of a secondary cache, a condition determining unit determines whether the write unit area in the write destination extends across the management unit areas of the secondary cache and, if the write unit area in the write destination extends across the management unit areas, determines whether the already stored data in an unupdated area is to be retained based on the use condition of the management unit area that includes the unupdated area, in which the write data is not written, in the write unit area as the write destination. If the condition determining unit determines that the already stored data is to be retained, a secondary-cache reading/writing control unit writes the write data in the management unit area as the write destination while the already stored data is retained.

### CROSS-REFERENCE TO RELATED APPLICATION

This application is based upon and claims the benefit of priority of the prior Japanese Patent Application No. 2015-126942, filed on Jun. 24, 2015, the entire contents of which are incorporated herein by reference.

### FIELD

The embodiments discussed herein are related to a storage device, a cache-write control method, and a cache-write control program.

### BACKGROUND

In recent storage systems, or the like, there has been an increasing number of systems that use a NAND-type flash memory, such as a solid state drive (SSD), as a secondary cache, so as to improve the input/output (I/O) performance.

As an example of the above-described storage systems, there is a system that includes a host and a storage device. The host is an information processing apparatus, such as a server. The host issues I/O requests, such as write requests or read requests, to the storage device.

Furthermore, the storage device includes a dynamic random access memory (DRAM), a NAND-type flash memory, and a disk. The DRAM is used as a primary cache. Furthermore, the disk is an auxiliary storage device, such as a hard disk, that stores user data. The disk may be a logical unit that is configured by using multiple hard disks. Moreover, the NAND-type flash memory is used as a secondary cache, as its speed is faster than that of the disk, or the like.

There are two types of operations to write data to the secondary cache. One of the operations is to write new data from the disk to the secondary cache. Writing data, read from the disk, in the primary cache and the secondary cache is referred to as “staging”.

If staging is conducted, data is often managed in units of chunks in the primary cache and the secondary cache. A chunk is a unit of sets of continuous data. Furthermore, in some cases, the primary cache and the secondary cache have different sizes of data management units.

Specifically, primary caches are generally expensive and small in capacity; therefore, in order to conduct staging in an efficient manner, the chunk size is often set to be small. Conversely, in the case of secondary caches, they are larger in capacity than primary caches; therefore, it is possible to conduct staging on more surrounding areas of requested data, and thus the chunk size is often set to be larger than that of the primary cache.

In the case of staging, the size for writing to the secondary cache is the chunk size of the secondary cache or its integral multiple.

The other one of the operations is to extend the staging state by rewriting the existing data in the cache in response to a command from the host. In this case, the write data, transmitted from the host, is first written in the primary cache. Then, if the area corresponding to the written area in the primary cache exists in the secondary cache, the data written in the primary cache is applied to the secondary cache so as to keep the data consistency between the primary cache and the secondary cache. In this case, the write size is often equal to or less than the chunk size of the secondary cache.

Here, writing to the primary cache may be conducted in the unit size of I/O from the host. The unit size of I/O from the host corresponds to the logical block size of the disk. For example, in many operating systems (OSs), the logical block size of the disk is 512 bytes and, if it includes protection information, such as error checking and correction (ECC), it is 520 bytes.

Conversely, in the NAND-type flash memory that is used as a secondary cache, data is written in units of pages of the NAND-type flash memory. The page has the value that is a power of 2, such as 4 KB, or 8 KB. In order to write data with the size that is different from the page size or its integral multiple in the NAND-type flash memory, a read-modify-write operation is performed as described below. Writing data with the size that is different from the page size or its integral multiple is sometimes referred to as “non-page alignment data writing”.

Here, a read-modify-write operation is explained. In the case of non-page alignment data writing, part of the data is changed in any page of the secondary cache. In this case, writing is conducted in the secondary cache in units of pages; therefore, if the updated data is simply written in the page, the adjacent data other than the updated data, stored in the page, is damaged. Therefore, an operation is performed to read the contents of the page into the read-modify-write buffer once, merge the updated data and the read contents of the page in the buffer, and then write the merged data in the page. A read-modify-write operation is an operation to read data from the page of the secondary cache once, merge it with the new data, and then return it to the page again, as described above. In this way, if a read-modify-write operation is performed, it is possible to prevent damages to adjacent data.

Furthermore, as the technology for providing the primary and secondary caches, there is a conventional technology, in which, if the maximum time unused list of the primary cache is full, the list is scanned to determine unadjusted data that may be discarded and, if there is adjusted data, it is moved to the end of the list. Moreover, there is a conventional technology of an information processing apparatus that includes a NAND-type flash memory and a DRAM.

[Patent Literature 1] Japanese Laid-open Patent Publication No. 2007-141225

[Patent Literature 2] Japanese Laid-open Patent Publication No. 2009-211232

However, if a read-modify-write operation is performed, the number of accesses to the secondary cache becomes twice for reading and writing. Therefore, the number of accesses to the secondary cache is increased, and the throughput of the overall secondary cache is degraded.

In this regard, as the secondary cache conducts staging collectively on the wide range of data by using a larger chunk than that of the primary cache, some of the existing data is less accessed by the host in actuality. If a read-modify-write operation is performed to keep such data, it causes a reduction in the throughput. It is sometimes inefficient to keep the entire data by performing a read-modify-write operation in the secondary cache on a constant basis, as described above.

However, if the adjacent data of the write data is discarded without performing a read-modify-write operation on a constant basis, effective data in the secondary cache is reduced, while a reduction in the throughput may be prevented. Therefore, the hit rate of the secondary cache is decreased, and the performance of the entire system is degraded.

### SUMMARY

According to an aspect of an embodiment, a storage device includes: a cache, in which one-time data writing is conducted on each write unit area, and written data is managed for each management unit area; a determining unit that, when write data is written in part of a specific write unit area of the cache, determines whether the specific write unit area extends across the management unit areas of the cache and, when the specific write unit area extends across the management unit areas, determines whether already stored data in an unupdated area is to be retained based on a use condition of the management unit area that includes the unupdated area, in which the write data is not written, in the specific write unit area; and a writing unit that, when the determining unit determines that the already stored data is to be retained, writes the write data in the specific management unit area while the already stored data is retained.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a hardware configuration diagram of a storage device;

FIG. 2 is a software configuration diagram of the storage device;

FIG. 3 is a block diagram of the storage device according to the first embodiment;

FIG. 4 is a table of an example of a primary-cache management table;

FIG. 5 is a table of an example of the secondary-cache management table;

FIG. 6A is a graph that illustrates an example of the relationship between the level of priority, which is calculated on the basis of the number of accesses, and the area of the secondary cache;

FIG. 6B is a graph that illustrates another example of the relationship between the level of priority, which is calculated on the basis of the number of accesses, and the area of the secondary cache;

FIG. 7A is a diagram that illustrates an operation in a case where a read-modify-write operation is performed;

FIG. 7B is a diagram that illustrates an operation to write data after the adjacent chunk area is rendered invalid;

FIG. 8 is a diagram that illustrates data writing in the case of page alignment;

FIG. 9 is a diagram that illustrates data writing in a case where a read-modify-write operation is performed;

FIG. 10 is a diagram that illustrates a case where a read-modify-write operation is performed as the level of priority of the adjacent chunk area is higher than the threshold;

FIG. 11 is a diagram that illustrates data writing after the adjacent chunk area is rendered invalid;

FIG. 12 is a diagram that illustrates non-page alignment data writing on the page that is included in the single target area;

FIG. 13 is a table that illustrates the transitions of each of the management tables in a case where data writing is conducted after the adjacent chunk area is rendered invalid;

FIG. 14 is a flowchart of an operation to write data during write-access extension by the storage device according to the first embodiment;

FIG. 15 is a block diagram of the storage device according to a second embodiment; and

FIG. 16 is a flowchart of an operation to write data during write-access extension by the storage device according to the second embodiment.

### DESCRIPTION OF EMBODIMENTS

Preferred embodiments of the present invention will be explained with reference to accompanying drawings. Here, the storage device, the cache-write control method, and the cache-write control program, disclosed in the subject application, are not limited to the following embodiments.

### [a] First Embodiment

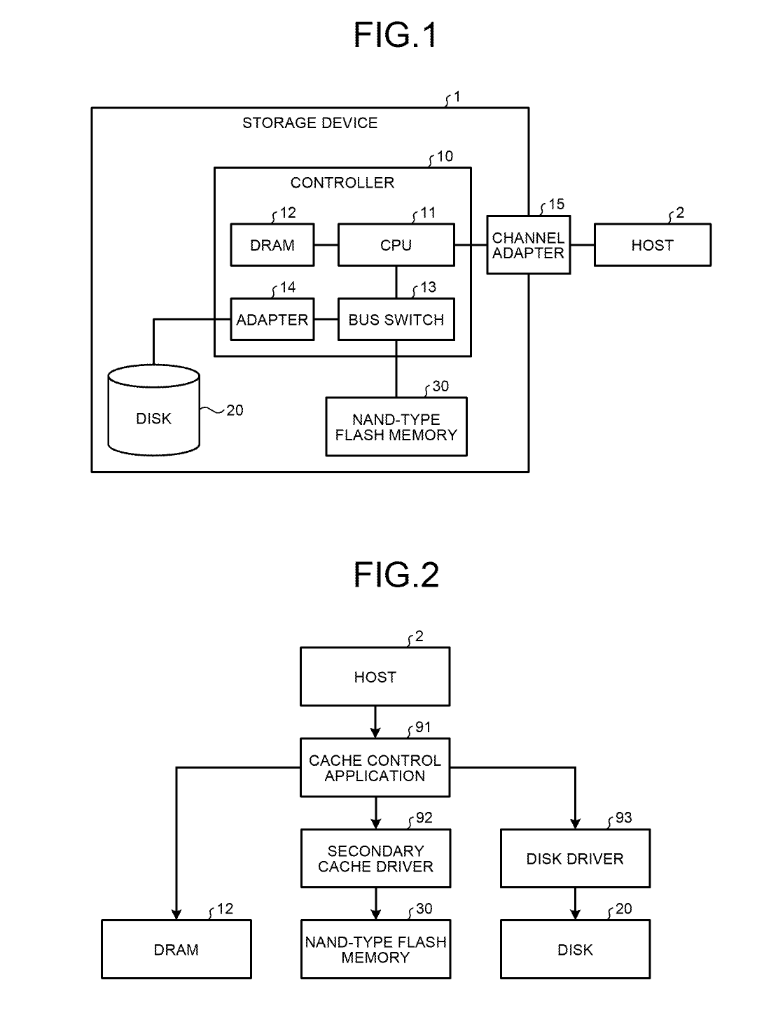

FIG. 1 is a hardware configuration diagram of a storage device. As illustrated in FIG. 1, a storage device 1 includes a controller 10, a disk 20, and a NAND-type flash memory 30.

The controller 10 manages data reading and writing in the storage device 1. The controller 10 includes a central processing unit (CPU) 11, a DRAM 12, a bus switch 13, and an adapter 14. A host 2 is an information processing apparatus, such as a server.

The CPU 11 is a calculation processing apparatus in the storage device 1. The CPU 11 is connected to the host 2 via a channel adapter 15. Furthermore, the CPU 11 transmits and receives data and commands to and from the host 2.

Moreover, the CPU 11 receives a command from the host 2, or the like, so that it controls data reading and writing in the storage device 1. For example, the CPU 11 executes the application for controlling a cache so as to operate it. Furthermore, for example, the CPU 11 executes a driver, firmware, or the like, for operating a cache so as to operate it.

The DRAM 12 has a function as a primary cache that temporarily stores data during reading and writing data from and to the host 2 in order to increase the speed of data reading and writing. Data reading and writing from and to the DRAM 12 are conducted by using the unit size of IO from the host 2, i.e., the logical block size of the disk 20.

The bus switch 13 receives a command from the CPU 11 and then switches the route of the bus, connected from the CPU 11, to any one of the disk 20 and the NAND-type flash memory 30. As described above, in actuality, the connection from the CPU 11 to the disk 20 or the NAND-type flash memory 30 is made via the bus switch 13; however, in the following explanation, switching and intermediation of the bus switch 13 are sometimes omitted.

The adapter 14 is an adapter that connects the bus, extending from the CPU 11, to the disk 20. As for this, in actuality, the CPU 11 transmits and receives data to and from the disk 20 via the adapter 14; however, in the following explanation, intermediation of the adapter 14 is sometimes omitted.

The disk 20 is an auxiliary storage device, such as a hard disk. The NAND-type flash memory 30 is, for example, an SSD, and it has a function as a secondary cache that temporarily stores data in order to increase the speed of data reading and writing.

In the NAND-type flash memory 30, data reading is conducted by using the logical block size of the disk 20, as is the case with the DRAM 12. Conversely, in the NAND-type flash memory 30, data writing is conducted in units of pages. Furthermore, in the NAND-type flash memory 30, data deletion is conducted in units of blocks, i.e., sets of pages. The page in the NAND-type flash memory 30 is an example of “write unit area”. In the NAND-type flash memory 30, data deletion is conducted on a block, of which all the data storage areas are invalid.

Next, with reference to FIG. 2, an explanation is given of various types of software that are executed in the storage device 1 to perform data reading and writing. FIG. 2 is a software configuration diagram of the storage device.

The CPU 11 of FIG. 1 executes a cache control application 91, a secondary cache driver 92, and a disk driver 93, illustrated in FIG. 2, so as to operate them. For example, the disk 20 stores various programs for implementing the cache control application 91, the secondary cache driver 92, and the disk driver 93.

The cache control application 91 performs control on the primary cache, implemented by the DRAM 12, and the secondary cache, implemented by the NAND-type flash memory 30. For example, the cache control application 91 manages the management tables of the primary cache and the secondary cache. Specifically, the cache control application 91 uses the management tables to manage validity/invalidity of data storage areas of the primary cache and the secondary cache. For example, when data reading is conducted, the cache control application 91 uses the management tables to determine whether the read data is hit in the primary cache and the secondary cache.

Furthermore, the cache control application 91 receives a command from the host 2 and conducts data reading and writing on the primary cache. Moreover, the cache control application 91 receives a command from the host 2 and transmits, to the disk driver 93, a command to read and write data from and to the disk 20.

Furthermore, the cache control application 91 receives a command from the host 2 and transmits, to the secondary cache driver 92, a command to read and write data from and to the secondary cache. In this case, the cache control application 91 determines the data write destination in the secondary cache. For example, the cache control application 91 determines that the write destination of the new data is the chunk of the secondary cache, of which the entire area is invalid, or the chunk of the secondary cache, which is referred to at the earliest time due to least recently used (LRU) management.

The secondary cache driver 92 receives, from the cache control application 91, a command to read and write data from and to the NAND-type flash memory 30. Then, in response to the received command, the secondary cache driver 92 reads and writes data from and to the NAND-type flash memory 30.

Furthermore, as described later, during data writing, the secondary cache driver 92 determines the level of priority of each chunk of the secondary cache, which is implemented by the NAND-type flash memory 30. Then, in accordance with the determined level of priority, the secondary cache driver 92 determines whether the data in the chunk, including the page where the data is to be written, is discarded or a read-modify-write operation is performed.

The disk driver 93 receives, from the cache control application 91, a command to read and write data from and to the disk 20. Then, in response to the received command, the disk driver 93 reads and writes data from and to the disk 20.

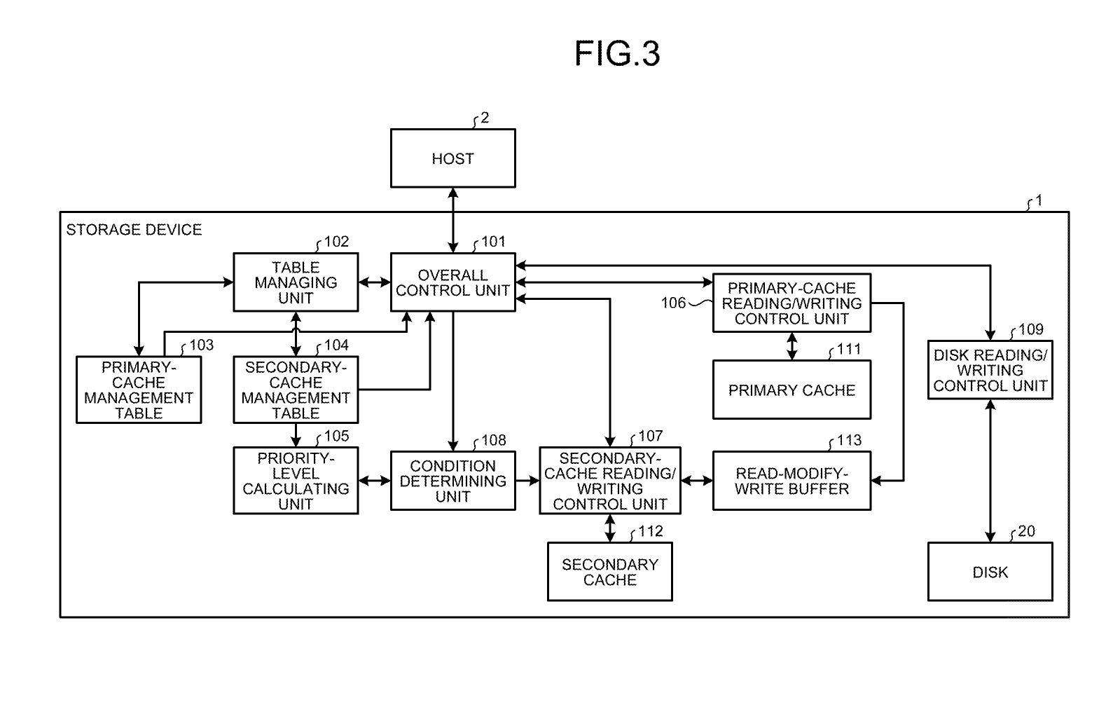

Next, with reference to FIG. 3, a detailed explanation is given of data reading and writing from and to the DRAM 12 and the NAND-type flash memory 30 in the storage device 1. FIG. 3 is a block diagram of the storage device according to the first embodiment.

As illustrated in FIG. 3, the storage device 1 according to the present embodiment includes an overall control unit 101, a table managing unit 102, a primary-cache management table 103, a secondary-cache management table 104, and a priority-level calculating unit 105. Furthermore, the storage device 1 includes a primary-cache reading/writing control unit 106, a secondary-cache reading/writing control unit 107, a condition determining unit 108, and a disk reading/writing control unit 109. Furthermore, the storage device 1 includes a primary cache 111, a secondary cache 112, a read-modify-write buffer 113, and the disk 20.

The cache control application 91, illustrated in FIG. 2, implements the functions of the overall control unit 101, the table managing unit 102, the priority-level calculating unit 105, and the primary-cache reading/writing control unit 106. Furthermore, the secondary cache driver 92 implements the functions of the secondary-cache reading/writing control unit 107 and the condition determining unit 108.

Furthermore, the DRAM 12 implements the primary cache 111 and the read-modify-write buffer 113. Furthermore, the DRAM 12 stores the primary-cache management table 103 and the secondary-cache management table 104. Moreover, the NAND-type flash memory 30 implements the secondary cache 112.

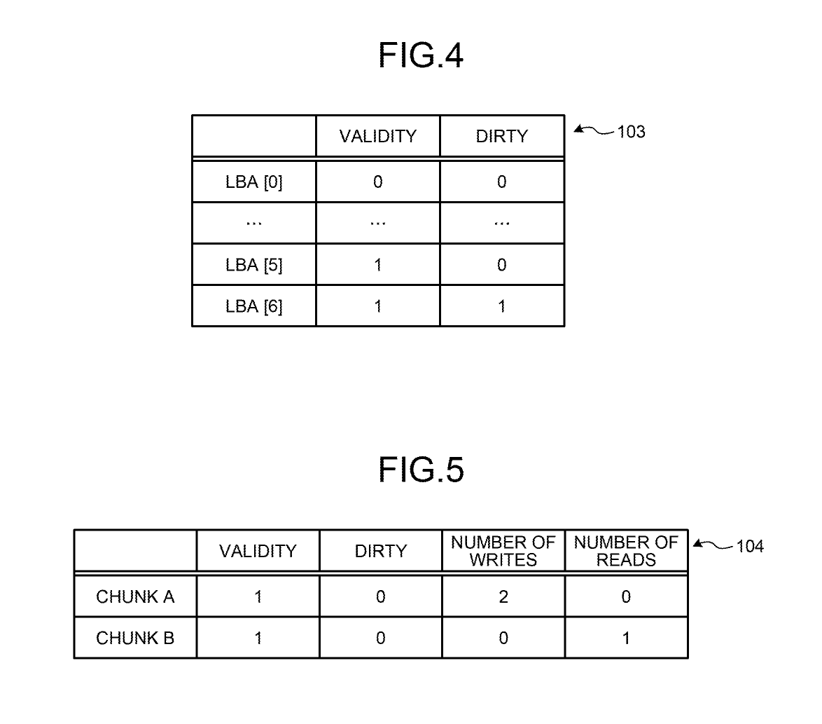

FIG. 4 is a table of an example of the primary-cache management table. The primary-cache management table 103 registers a validity flag and a dirty flag for each logical block. A logical block address (LBA) in FIG. 4 indicates the identification information on a logical block. The validity flag has the value “1” if the corresponding logical block is valid, and it has the value “0” if invalid. Validity of a logical block indicates whether the logical block is deployed from the disk 20 or the secondary cache 112. For example, during staging of the read area, designated by the host 2, into the primary cache 111, if only the read area is staged instead of staging all the chunks from the disk 20 or the secondary cache 112, the logical block, which is the unstaged area within the chunk, is invalid.

Furthermore, if the value of the dirty flag is “1”, it indicates that the write data from the host 2, which has not been written back to the disk 20, is stored in the corresponding logical block. The write data from the host 2, which has not been written back to the disk 20, is referred to as “dirty data”. If the dirty flag has the value “0”, it indicates that the dirty data is not written in the corresponding logical block.

More specifically, the primary-cache management table 103 has the chunk identifier (ID), which is the identification information on a chunk of the primary cache 111, in a related manner. Furthermore, the primary-cache management table 103 includes other types of management information, such as the start address in the DRAM 12, the start logical block address of stored data in the disk 20, the state of each logical block, or LRU information.

Here, according to the present embodiment, the primary cache 111 is managed in units of logical blocks, and the secondary cache 112 is managed in units of chunks of the primary cache 111; however, these are not limitations on the management unit. For example, it is possible that the primary cache 111 is collectively staged in units of chunks and the valid/invalid state of each chunk is managed. Furthermore, a chunk of the secondary cache 112 may be managed on a per logical-block basis. Here, the management unit of the secondary cache 112 is the unit for determination as to whether data is to be discarded or retained as described later.

FIG. 5 is a table of an example of the secondary-cache management table. In the secondary-cache management table 104, for example, a table is provided for each chunk of the secondary cache 112. FIG. 5 illustrates the secondary-cache management table 104 that corresponds to a single chunk. The secondary-cache management table 104 registers multiple chunks of the primary cache 111, corresponding to the chunk of the secondary cache 112, indicated by the table. That is, with the information on the chunk of the primary cache 111, the area of the secondary cache 112, which corresponds to the chunk, is indicated in the secondary-cache management table 104. Hereafter, the area of the secondary cache 112, indicated by using the identification information on the chunk of the primary cache 111, registered in the secondary-cache management table 104, is referred to as the “corresponding area” of the chunk of the primary cache 111. Conversely, the chunk of the primary cache 111, which corresponds to each corresponding area of the secondary cache 112, is referred to as the “corresponding chunk” of the corresponding area of the secondary cache 112. The corresponding area is an example of a “management unit area”.

Furthermore, the secondary-cache management table 104 registers the validity flag, the dirty flag, the number of reads, and the number of writes with regard to each corresponding area that is indicated by using the identification information on each chunk of the primary cache 111. The validity flag has the value “1” if the corresponding area is valid, and it has the value “0” if invalid. Furthermore, if the dirty flag has the value “1”, it is indicated that the write data from the host 2, which has not been written back to the disk 20, is stored in the corresponding area. If the dirty flag has the value “0”, it is indicated that the dirty data is not written in the corresponding area.

More specifically, the secondary-cache management table 104 has the chunk ID, which is the identification information on a chunk of the secondary cache 112, in a related manner. Furthermore, the secondary-cache management table 104 includes other types of management information, such as the start address in the NAND-type flash memory 30, the start logical block address of stored data in the disk 20, the state of each corresponding area included in the chunk, or least recently used (LRU) information.

The overall control unit 101 performs the overall management on data reading and writing from and to the primary cache 111, the secondary cache 112, and the disk 20. A detailed explanation is given below of the function of the overall control unit 101.

The overall control unit 101 receives, from the host 2, a command to read data from the disk 20. Then, the overall control unit 101 refers to the primary-cache management table 103 and the secondary-cache management table 104 so as to determine whether the read data is hit in any of the primary cache 111 and the secondary cache 112.

If there is a hit in the primary cache 111, the overall control unit 101 gives a command to the primary-cache reading/writing control unit 106 to read data. Afterward, the overall control unit 101 acquires, from the primary-cache reading/writing control unit 106, the data, for which the read command has been made. Then, the overall control unit 101 transmits the acquired data to the host 2.

Furthermore, if there is no hit in the primary cache 111 but there is a hit in the secondary cache 112, the overall control unit 101 gives a command to the secondary-cache reading/writing control unit 107 to read data. Afterward, the overall control unit 101 acquires, from the secondary-cache reading/writing control unit 107, the data, for which the read command has been made. Then, the overall control unit 101 transmits the acquired data to the host 2. Furthermore, the overall control unit 101 notifies the table managing unit 102 of the identification information on the corresponding chunk, indicating the area of the secondary cache 112, from which the data has been read, and the data read notification.

Conversely, if there is no hit, the overall control unit 101 requests the disk reading/writing control unit 109 to read the designated data from the disk 20. Afterward, the overall control unit 101 acquires, from the disk reading/writing control unit 109, the data, for which the read command has been made. Then, the overall control unit 101 transmits the read data to the host 2. Furthermore, the overall control unit 101 transmits the data, read from the disk 20, to the primary-cache reading/writing control unit 106 or the secondary-cache reading/writing control unit 107 and gives a command to write the data. That is, the overall control unit 101 conducts staging. If the data is written to the secondary cache 112, the overall control unit 101 notifies the table managing unit 102 of the identification information on the corresponding chunk, indicating the area of the secondary cache 112, in which the data has been written, and the data write notification.

Furthermore, the overall control unit 101 receives, from the host 2, a command to write data in the disk 20. Then, the overall control unit 101 refers to the primary-cache management table 103 and the secondary-cache management table 104 so as to determine whether the write data is hit in any of the primary cache 111 and the secondary cache 112.

If there are no hits for the write data, the overall control unit 101 transmits, to the disk reading/writing control unit 109, a command to write the data in the disk 20. Furthermore, if there is data that is difficult to be instantaneously written to the disk 20 by the disk reading/writing control unit 109, the overall control unit 101 transmits the data to the primary-cache reading/writing control unit 106 and the secondary-cache reading/writing control unit 107 together with designation of the logical block as the write destination.

If the data has been written to the primary cache 111, the overall control unit 101 outputs, to the table managing unit 102, the identification information on the logical block of the primary cache 111, to which the data has been written, and the dirty notification. In the same manner, if the data has been written to the secondary cache 112, the overall control unit 101 outputs, to the table managing unit 102, the identifier of the corresponding chunk, indicating the area of the secondary cache 112, to which the data has been written, the data write notification, and the dirty notification.

Afterward, when the disk reading/writing control unit 109 enters a state where new data may be written to the disk 20, the overall control unit 101 acquires the data to be written from the primary-cache reading/writing control unit 106 or the secondary-cache reading/writing control unit 107. Then, the overall control unit 101 transmits the acquired data to the disk reading/writing control unit 109 so that it is written to the disk 20.

In this case, if the data is read from the primary cache 111, the overall control unit 101 outputs, to the table managing unit 102, the identification information on the logical block of the primary cache 111, from which the data has been read, and the dirty cancellation notification.

In the same manner, if the data is read from the secondary cache 112, the overall control unit 101 outputs, to the table managing unit 102, the identifier of the corresponding chunk, indicating the area of the secondary cache 112, from which the data has been read, and the data read notification. Furthermore, the overall control unit 101 outputs, to the table managing unit 102, the dirty cancellation notification for the area of the secondary cache 112, from which the data has been read.

Furthermore, if the write data is hit in the primary cache 111, the overall control unit 101 gives a command to the primary-cache reading/writing control unit 106 to write over the hit area of the primary cache 111 with new data. Furthermore, if the write data is not hit in the primary cache 111 but it is hit in the secondary cache 112, the overall control unit 101 transmits, to the primary-cache reading/writing control unit 106, the data to be written in the primary cache 111 together with designation of the logical block as the write destination.

Furthermore, in any case, the overall control unit 101 outputs, to the table managing unit 102, the identification information on the logical block of the primary cache 111, to which the data has been written, and the dirty notification. Afterward, if the secondary cache 112 contains the corresponding area of the chunk of the primary cache 111, in which the data has been updated, the overall control unit 101 gives a command to the secondary-cache reading/writing control unit 107 to change the data i.e., write the data, so as to keep the consistency between the caches. In this case, the overall control unit 101 outputs, to the secondary-cache reading/writing control unit 107, the identification information on the corresponding chunk, indicating the area of the secondary cache 112, in which the data is to be changed. Hereafter, writing to the secondary cache 112 in order to keep the consistency between the caches if the secondary cache contains the corresponding area of the chunk of the primary cache 111 is referred to as the “write-access extended writing”.

If the write-access extended writing is conducted, the overall control unit 101 gives a command to the condition determining unit 108 to determine whether a read-modify-write operation is performed. In this case, the overall control unit 101 transmits, to the condition determining unit 108, the information on the area of the secondary cache 112, in which the data is changed.

Afterward, if the read-modify-write operation is performed, the overall control unit 101 receives the notification of execution of the read-modify-write operation from the condition determining unit 108. Then, the overall control unit 101 gives a command to the primary-cache reading/writing control unit 106 to write the write data to the read-modify-write buffer 113. Furthermore, the overall control unit 101 outputs, to the table managing unit 102, the identification information on the corresponding chunk, indicating the area of the secondary cache 112, from which the data has been read during the read-modify-write operation, and the data read notification. Furthermore, the overall control unit 101 outputs, to the table managing unit 102, the identification information on the corresponding chunk, indicating the area of the secondary cache 112, to which the data has been written during the read-modify-write operation, and the data write notification.

Conversely, if a read-modify-write operation is not performed, there is a case where writing is conducted after the adjacent chunk area is rendered invalid or a case where writing is conducted without rendering invalid the adjacent chunk area, i.e., writing is simply conducted. Here, the adjacent chunk area refers to the corresponding area that includes the logical block, in which the data is not updated, if the page area of the write destination extends across different corresponding areas of chunk of the primary cache 111 when the data is written in the secondary cache 112. Invalidity of the adjacent chunk area is described in detail later.

If the adjacent chunk area is rendered invalid, the overall control unit 101 receives invalidity of the adjacent chunk area and the data write notification from the secondary-cache reading/writing control unit 107. Then, the overall control unit 101 outputs, to the table managing unit 102, the identification information on the corresponding chunk, indicating the corresponding area that is rendered invalid, the identification information on the corresponding chunk, indicating the corresponding area, to which the data has been written, and the data write notification.

Conversely, if the adjacent chunk is not rendered invalid, the overall control unit 101 receives the data write notification from the secondary-cache reading/writing control unit 107. Then, the overall control unit 101 outputs, to the table managing unit 102, the identification information on the corresponding chunk, indicating the area of the secondary cache 112, to which the data has been written, and the data write notification.

If the data is temporarily is stored in the primary cache 111 during data writing to the disk 20, the table managing unit 102 receives, from the overall control unit 101, inputs of the information on the logical block as the data storage destination and the dirty notification. Also, if the write data is hit in the primary cache 111 or the secondary cache 112 or in both of them when the write request is received, the table managing unit 102 receives, from the overall control unit 101, inputs of the information on the logical block as the data storage destination and the dirty notification.

Then, the table managing unit 102 sets the dirty flag of the logical block, for which the notification is received, in the primary-cache management table 103 to “1”. Then, after receiving the information on the logical block of the data read source and the dirty cancellation notification, the table managing unit 102 returns the dirty flag of the logical block, for which the notification is received, in the primary-cache management table 103 to “0”.

In the same manner, if the data is temporarily stored in the secondary cache 112 during data writing to the disk 20, the table managing unit 102 receives, from the overall control unit 101, inputs of the identification information on the corresponding chunk, indicating the area of the secondary cache 112 as the data storage destination, and the dirty notification. Then, the table managing unit 102 sets the dirty flag of the corresponding area, indicated by using the identifier of the corresponding chunk in the secondary-cache management table 104, to “1”. Then, after receiving the identification information on the corresponding chunk, indicating the corresponding area of the data read source, and the dirty cancellation notification, the table managing unit 102 returns the dirty flag of the corresponding area, indicated by using the identification information on the corresponding chunk, for which the notification is received, to “0”.

Furthermore, when write-access extended writing is conducted on the secondary cache 112, the table managing unit 102 receives inputs of different types of information from the overall control unit 101 depending on whether writing is simply conducted, read-modify-write is conducted, or an adjacent chunk area is rendered invalid.

If writing is simply conducted, the table managing unit 102 receives, from the overall control unit 101, inputs of the identification information on the corresponding chunk, indicating the area of the secondary cache 112, to which the data has been written, and the data write notification. Here, the table managing unit 102 includes, for each corresponding area, the counter that counts the number of writes and the counter that counts the number of reads. Furthermore, the table managing unit 102 increments the counter by 1 for the number of writes of the corresponding area, indicated by using the identification information on the corresponding chunk, for which the notification has been received.

Furthermore, if read-modify-write is conducted, the table managing unit 102 outputs, to the overall control unit 101, the identification information on the corresponding chunk, indicating the area of the secondary cache 112, to which the data has been written during the read-modify-write operation, and the data write notification. Then, the table managing unit 102 increments the counter by 1 for the number of writes of the corresponding area, indicated by using the corresponding chunk, for which the notification has been received.

Furthermore, an explanation is given of a case where an adjacent chunk area is rendered invalid, i.e., a case where the data in an adjacent chunk area is discarded. In this case, the table managing unit 102 receives, from the overall control unit 101, inputs of the identification information on the corresponding chunk, indicating the adjacent chunk area that is rendered invalid, the identification information on the corresponding chunk, indicating the area of the secondary cache 112, to which the data has been written, and the data write notification. Then, the table managing unit 102 sets the validity flag of the adjacent chunk area, which is rendered invalid, to “0”. Furthermore, the table managing unit 102 increments the counter by 1 for the number of writes of the area of the secondary cache 112, to which the data has been written.

Furthermore, the table managing unit 102 updates the values of the number of writes and the number of reads of each corresponding area in the secondary-cache management table 104 to the values of the counters for the number of writes and the number of reads of each corresponding area at each set period of time. Then, the table managing unit 102 initializes the values of the counters for the number of reads and the number of writes of each corresponding area so as to set them to 0. That is, the table managing unit 102 repeatedly writes the values of the number of writes and the number of reads of each corresponding area for a certain period of time in the secondary-cache management table 104.

In the case of the write-access extension, the condition determining unit 108 receives, from the overall control unit 101, a request for determination as to whether a read-modify-write operation is performed together with the information on the area of the secondary cache 112, to which the data is written. Then, in accordance with the following steps, the condition determining unit 108 makes a determination as to whether a read-modify-write operation is performed. Here, data is written in the secondary cache 112 in units of pages of the secondary cache 112; therefore, the condition determining unit 108 makes a determination as to whether a read-modify-write operation is performed in units of pages of the secondary cache 112.

First, the condition determining unit 108 determines whether the write size, i.e., the size of the area of the secondary cache 112, to which data is written, is the integral multiple of the page size of the secondary cache 112 and whether the start position of the area of the NAND-type flash memory 30, on which writing is conducted, is the integral multiple of the page size. If the write size is the integral multiple of the page size, it can be said that the area of the secondary cache 112, to which data is written, has page alignment. In such a case, the condition determining unit 108 determines that simple data writing is to be performed without conducting read-modify-write. Then, the condition determining unit 108 gives a command to the secondary-cache reading/writing control unit 107 to simply write data in the secondary cache 112.

Conversely, if the write size is not the integral multiple of the page size or if the start position of the area, on which writing is conducted, is not the integral multiple of the page size, it can be said that the area of the secondary cache 112, in which data is written, has non-page alignment. In this case, the condition determining unit 108 determines whether there is a write destination page that includes a logical block, in which the data is not updated, and that extends across different target areas. Hereafter, a write destination page that includes a logical block, in which the data is not updated, and that extends across different target areas is referred to as the “determination target page”.

If there is no determination target page, the condition determining unit 108 determines that a read-modify-write operation is to be performed. Then, the condition determining unit 108 gives a command to the secondary-cache reading/writing control unit 107 to perform a read-modify-write operation.

If there is a determination target page, the condition determining unit 108 determines whether the adjacent chunk area of the determination target page includes only a logical block, in which the data is not updated, and the area other than the adjacent chunk of the determination target page include only a logical block, in which the data is updated. Hereafter, the target area other than the adjacent chunk area, included in the determination target page, is referred to as the “write chunk area”. That is, the condition determining unit 108 determines whether the boundary between the logical block, in which the data is updated, and the logical block, in which the data is not updated, matches the boundary between the adjacent chunk area and the write chunk area. Hereafter, the case where the boundary between the logical block, in which the data is updated, and the logical block, in which the data is not updated, matches the boundary between the adjacent chunk area and the write chunk area is referred to as “boundary match”.

If there is no boundary match, the condition determining unit 108 determines that a read-modify-write operation is to be performed. Then, the condition determining unit 108 gives a command to the secondary-cache reading/writing control unit 107 to perform a read-modify-write operation.

Conversely, if there is a boundary match, the condition determining unit 108 outputs, to the priority-level calculating unit 105, a request to calculate the level of priority of the adjacent chunk area, together with the identification information on the corresponding chunk, indicating the adjacent chunk area. Afterward, the condition determining unit 108 receives an input of the level of priority of the adjacent chunk area from the priority-level calculating unit 105. Then, the condition determining unit 108 determines whether the level of priority of the adjacent chunk area is equal to or more than a predetermined threshold. If the level of priority of the adjacent chunk area is equal to or more than the predetermined threshold, the condition determining unit 108 determines that a read-modify-write operation is to be performed. Then, the condition determining unit 108 gives a command to the secondary-cache reading/writing control unit 107 to perform a read-modify-write operation.

Conversely, if the level of priority of the adjacent chunk area is less than the threshold, the condition determining unit 108 determines that the adjacent chunk area is invalid. Then, the condition determining unit 108 notifies the secondary-cache reading/writing control unit 107 that the adjacent chunk area is invalid. The condition determining unit 108 is an example of a “determining unit”.

Here, the threshold for the level of priority is the value that is the index as to whether data in the secondary cache 112 is to be kept or discarded. Furthermore, it is preferable that the threshold for the level of priority is determined on the basis of the average access pattern that is handled by the system.

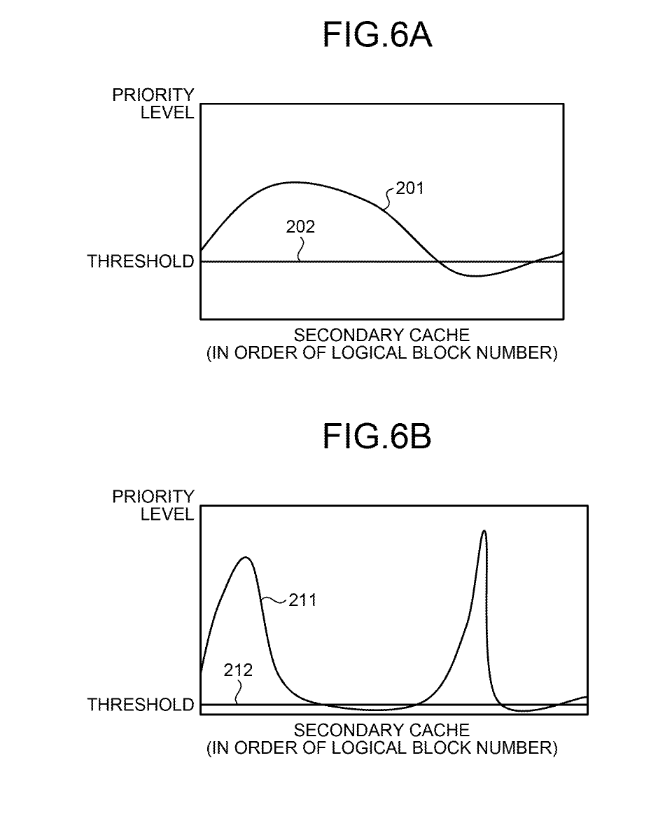

Furthermore, with reference to FIGS. 6A and 6B, an explanation is given of an example of the method for determining the threshold for the level of priority. FIG. 6A is a graph that illustrates an example of the relationship between the level of priority, which is calculated on the basis of the number of accesses, and the area of the secondary cache. Furthermore, FIG. 6B is a graph that illustrates another example of the relationship between the level of priority, which is calculated on the basis of the number of accesses, and the area of the secondary cache. In FIGS. 6A and 6B, the vertical axis indicates the level of priority, and the horizontal axis indicates the corresponding area of the secondary cache 112, arranged in the order of the number of the logical block. Here, the number of accesses is the number of times data reading and writing is conducted on each logical block. Furthermore, the level of priority is proportional to the number of accesses. That is, in FIGS. 6A and 6B, as the number of accesses increases, the value in the vertical axis becomes larger. The method for calculating the level of priority by using the number of accesses is described later in detail.

It is considered that the number of accesses with regard to each corresponding area of the secondary cache 112, which corresponds to the chunk of the primary cache 111, has the temporal locality and the spatial locality based on the logical block number. That is, the histogram, indicating the relationship between the number of accesses and each corresponding area of the secondary cache 112, is represented by overlapping the normal distributions as in FIGS. 6A and 6B. It may be considered that, as the level of priority is proportional to the number of accesses, FIGS. 6A and 6B represent the relationship between the level of priority and each corresponding area of the secondary cache 112.

Here, as the threshold becomes higher, there is a higher possibility that the adjacent chunk area is rendered invalid. If the adjacent chunk area is rendered invalid, there is an increase in the data that is discarded in the secondary cache 112. If lots of data is discarded in the secondary cache 112, the read hit rate is decreased, and the processing efficiency of the system is reduced. Therefore, it is preferable that the amount of invalid areas is small in relation to all the areas of the secondary cache 112.

For example, in the case of the system where the distribution is large and the average value of the level of priority is large, as represented by a graph 201 that is illustrated in FIG. 6A, even if a threshold 202 is a relatively high value, the data that is discarded in the secondary cache 112 may be small. However, in the case of the system where the number of accesses is centered on a few areas, as represented by a graph 211 that is illustrated in FIG. 6B, if a threshold 212 is high, there is a possibility that lots of data is discarded from the secondary cache 112. Therefore, it is preferable that the threshold 212 is low in such a system. As described above, it is preferable that the threshold is determined in accordance with the trend of the number of accesses in the secondary cache 112.

The priority-level calculating unit 105 receives, from the condition determining unit 108, a request to calculate the level of priority together with the identification information on the corresponding chunk, indicating the adjacent chunk area. When the priority-level calculating unit 105 receives the request to calculate the level of priority, it first uses the secondary-cache management table 104 to determine whether the adjacent chunk area includes dirty data. If the adjacent chunk area includes dirty data, the priority-level calculating unit 105 sets the level of priority of the adjacent chunk area to infinity. Thus, if the adjacent chunk area includes dirty data, the level of priority of the adjacent chunk is equal to or more than the threshold.

Conversely, if the adjacent chunk area does not include dirty data, the priority-level calculating unit 105 acquires the number of writes and the number of reads of the adjacent chunk area from the secondary-cache management table 104. Then, the priority-level calculating unit 105 adds the divided value of the number of reads by the number of writes to the total of the number of writes and the number of reads, thereby calculating the level of priority of the adjacent chunk area. Specifically, if the level of priority of the number of writes is P, the number of writes is R, and the number of reads is W, the priority-level calculating unit 105 uses P=R+W+(R/W) to calculate the level of priority of the adjacent chunk area. In this way, the ratio between the number of reads and the number of writes is applied to the level of priority and thus the one with a higher ratio of the number of reads has a higher level of priority of the adjacent chunk.

Afterward, the priority-level calculating unit 105 transmits the obtained level of priority of the adjacent chunk area to the condition determining unit 108.

The primary-cache reading/writing control unit 106 receives a data write command from the overall control unit 101, and it writes the data in the designated logical block of the primary cache 111. Furthermore, the primary-cache reading/writing control unit 106 receives a data read command from the overall control unit 101, reads the designated data from the primary cache 111, and transmits it to the overall control unit 101.

Furthermore, if read-modify-write is to be performed, the primary-cache reading/writing control unit 106 receives, from the overall control unit 101, a command to output the data, which is to be written in the secondary cache 112, to the read-modify-write buffer 113. Then, the primary-cache reading/writing control unit 106 reads the designated data from the primary cache 111 and writes it in the read-modify-write buffer 113.

The secondary-cache reading/writing control unit 107 receives a data write command from the overall control unit 101. At this point, in the case of writing to the secondary cache 112 due to write-access extension from the host 2, the secondary-cache reading/writing control unit 107 receives, from the condition determining unit 108, the designation as to whether simple writing is conducted, a read-modify-write operation is performed, or data is written after the adjacent chunk area is rendered invalid.

In the case of simple writing, the secondary-cache reading/writing control unit 107 writes the data in the designated page. In this case, the secondary-cache reading/writing control unit 107 outputs the information on the target chunk, on which writing has been conducted, and the data write notification to the overall control unit 101.

Furthermore, in the case of a read-modify-write operation, the secondary-cache reading/writing control unit 107 reads the data from the target page of the secondary cache 112. Next, the secondary-cache reading/writing control unit 107 writes the read data in the read-modify-write buffer 113 and merges it with the data that is written by the primary-cache reading/writing control unit 106. Then, the secondary-cache reading/writing control unit 107 acquires the merged data from the read-modify-write buffer 113 and writes it in the target page of the secondary cache 112. In this case, the secondary-cache reading/writing control unit 107 transmits the identification information on the target chunk, indicating the area of the secondary cache 112, on which data reading and writing back have been conducted, the read notification, and the write notification to the overall control unit 101.

Furthermore, in the case of writing of data after the adjacent chunk area is rendered invalid, the secondary-cache reading/writing control unit 107 notifies the overall control unit 101 that the adjacent chunk area is invalid. Next, the secondary-cache reading/writing control unit 107 writes the data in the target page of the secondary cache 112. Afterward, the secondary-cache reading/writing control unit 107 outputs, to the overall control unit 101, the identification information on the target chunk, indicating the area of the secondary cache 112, to which the data has been written, and the data write notification.

Furthermore, the secondary-cache reading/writing control unit 107 receives a data read command from the overall control unit 101, reads the designated data from the secondary cache 112, and transmits it to the overall control unit 101. Furthermore, the secondary-cache reading/writing control unit 107 outputs, to the overall control unit 101, the identification information on the target chunk, indicating the area of the secondary cache 112, from which the data has been read, and the data read notification. The secondary-cache reading/writing control unit 107 is an example of a “writing unit”.

The read-modify-write buffer 113 includes a temporary memory area in a case where a read-modify-write operation is performed. The read-modify-write buffer 113 is provided in, for example, the DRAM 12 of FIG. 1.

The disk reading/writing control unit 109 receives, from the overall control unit 101, a command to write data to the disk 20. Then, the disk reading/writing control unit 109 writes the designated data to the disk 20.

Furthermore, the disk reading/writing control unit 109 receives, from the overall control unit 101, a command to read data from the disk 20. Then, the disk reading/writing control unit 109 reads the designated data from the disk 20 and outputs it to the overall control unit 101.

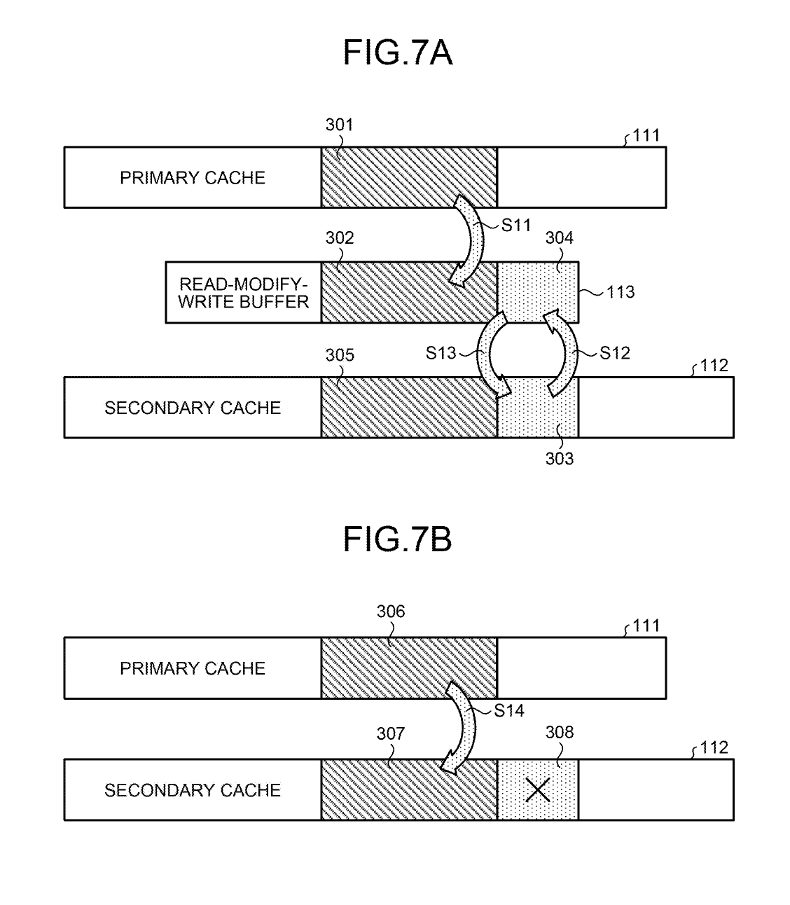

Next, with reference to FIGS. 7A and 7B, an explanation is given of the outline of a read-modify-write operation and an operation to write data after the adjacent chunk area is rendered invalid in the storage device 1 according to the present embodiment. FIG. 7A is a diagram that illustrates an operation in a case where a read-modify-write operation is performed. FIG. 7B is a diagram that illustrates an operation to write data after the adjacent chunk area is rendered invalid.

FIG. 7A is a case where data 301 in the primary cache 111 is updated. At this point, the primary-cache reading/writing control unit 106 reads the data 301 from the primary cache 111 and writes it in the read-modify-write buffer 113 (Step S11). The written data is data 302.

Next, the secondary-cache reading/writing control unit 107 reads data 303 from the secondary cache 112 and writes it in the read-modify-write buffer 113. The written data is data 304. Then, the secondary-cache reading/writing control unit 107 merges the data 302 and the data 304 (Step S12).

Next, the secondary-cache reading/writing control unit 107 reads the data 302 and 304, which has been merged, from the read-modify-write buffer 113, and writes it in the secondary cache 112. Thus, the data 303 is held in the secondary cache 112, while data 305, corresponding to the data 301, is written therein (Step S13).

FIG. 7B is a case where data 306 in the primary cache 111 is updated. At this point, the secondary-cache reading/writing control unit 107 renders an adjacent chunk area 308 invalid. Then, the secondary-cache reading/writing control unit 107 acquires the data 306, read from the primary cache 111, and writes it in the secondary cache 112. Thus, in the secondary cache 112, the adjacent chunk area 308 is rendered invalid, and data 307, corresponding to the data 306, is written (Step S14).

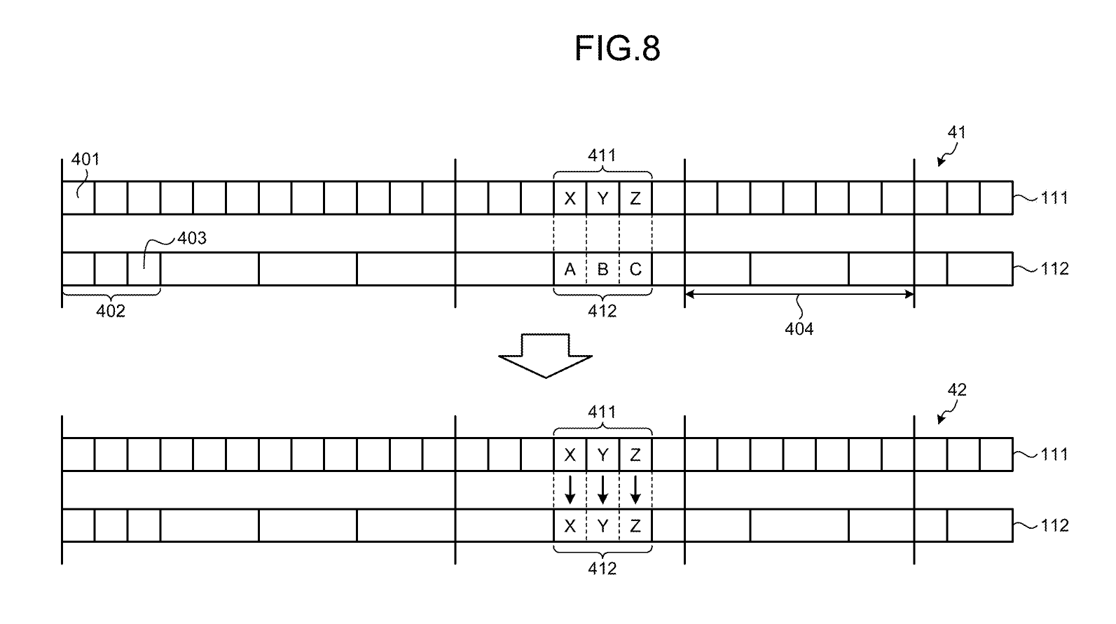

Next, with reference to FIG. 8, an explanation is given of data writing in a case where the write data has page alignment during write-access extension. FIG. 8 is a diagram that illustrates data writing in the case of page alignment. A state 41 illustrates a state before data is written in the secondary cache 112, and a state 42 illustrates a state after the data is written in the secondary cache 112.

A logical block 401 represents a logical block of the primary cache 111. Furthermore, a page 402 represents a page that is a unit for writing in the secondary cache 112. Furthermore, a logical block 403 represents a logical block of the secondary cache 112. The entire secondary cache 112 is divided in units of logical blocks; however, for the convenience of explanation, the logical block 403 is illustrated in only part of the secondary cache 112. Here, the explanation is given on the basis of the assumption that the single page 402 includes the three logical blocks 403. Furthermore, the corresponding area 404 represents the area in the case where the secondary cache 112 is divided by being related to a chunk of the primary cache 111.

In this case, there is an updated area 411 in the primary cache 111. The area 411 contains three sets of data X, Y, and Z. Furthermore, a page 412 in the secondary cache 112, which is a corresponding area of the area 411, stores three sets of data A, B, and C.

In this case, as the write size has page alignment, the secondary-cache reading/writing control unit 107 writes the data, stored in the area 411, to the page 412, which is the corresponding area, without change so as to update it. Therefore, the page 412 includes the data X, Y, and Z, which is the same as that in the area 411 of the primary cache 111. Thus, the consistency between the primary cache 111 and the secondary cache 112 is ensured.

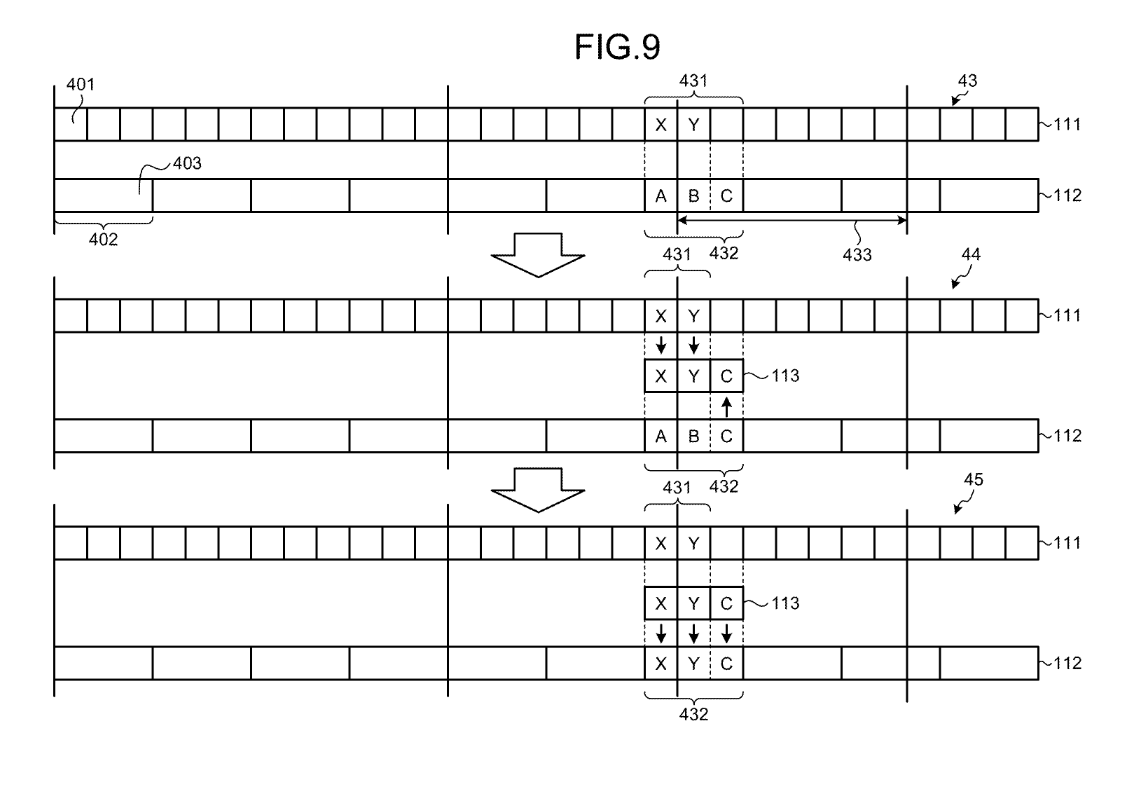

Next, with reference to FIG. 9, an explanation is given of data writing in a case where a read-modify-write operation is performed due to access extension. FIG. 9 is a diagram that illustrates data writing in a case where a read-modify-write operation is performed. A state 43 represents a state before data is written in the secondary cache 112. A state 44 represents a state in a case where data is stored in the read-modify-write buffer 113. A state 45 represents the state of the secondary cache 112 after a read-modify-write operation is performed.

In this case, as illustrated in the state 43, there is an updated area 431 in the primary cache 111. The area 431 includes two sets of data, i.e., X and Y. Furthermore, a page 432 of the secondary cache 112, including the area that corresponds to the area 431, stores three sets of data, i.e., A, B, and C.

In this case, the write size is a two-logical-block size, and it has non-page alignment. Furthermore, the page 432 of the secondary cache 112, which is the write target, extends across two target areas. Furthermore, an adjacent chunk area 433 is the corresponding area that includes the logical block of the page 432, of which the data is not updated in the corresponding area of the primary cache 111, i.e., the logical block that stores the data C.

Furthermore, the area of the primary cache 111, which corresponds to the adjacent chunk area 433, has the area where the data is updated, that is, there is no boundary match; therefore, in this case, a read-modify-write operation is performed. The primary-cache reading/writing control unit 106 writes the data in the area 431, i.e., the data X and Y, in the read-modify-write buffer 113. Furthermore, the secondary-cache reading/writing control unit 107 writes, in the read-modify-write buffer 113, the data in the logical block of the page 432, of which the data is not updated in the primary cache 111, i.e., the data C, and it merges X, Y, and C. Thus, the state is obtained as illustrated in the state 44.

Then, the secondary-cache reading/writing control unit 107 writes the data, stored in the read-modify-write buffer 113, in the page 432 so as to update it. Thus, the state is obtained as illustrated in the state 45. Specifically, the page 432 includes the data X and Y, which is the same as that in the area 431 of the primary cache 111, and the data C that is originally included. Thus, the consistency between the primary cache 111 and the secondary cache 112 is ensured, while the page 432 of the secondary cache 112 can retain the data in the logical block, of which the data is not updated in the area of the primary cache 111.

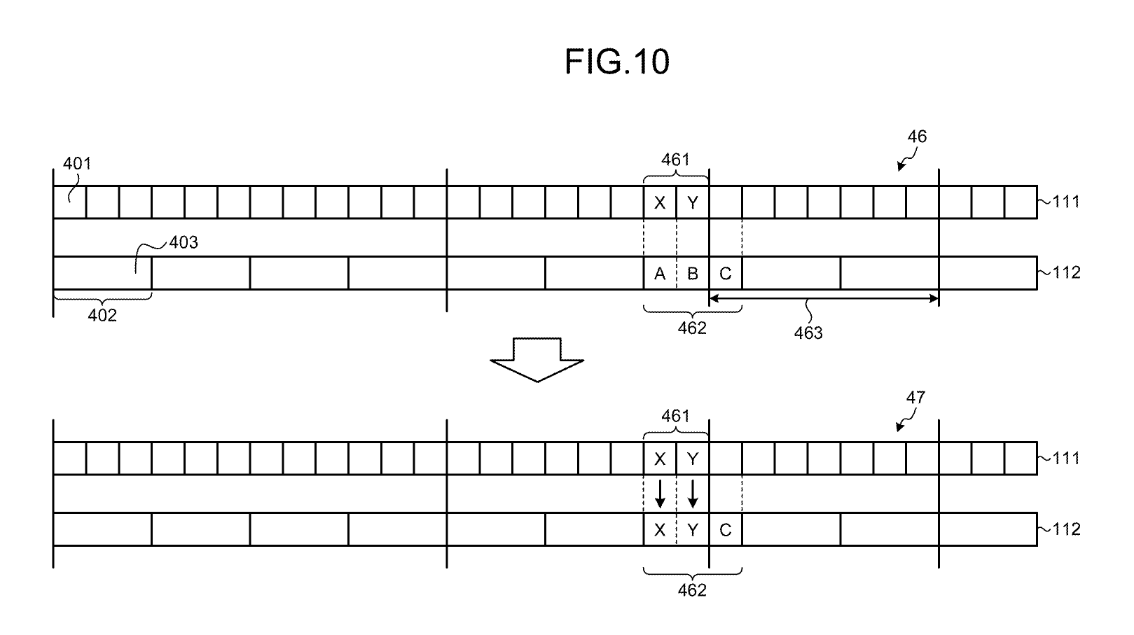

Next, with reference to FIG. 10, an explanation is given of a case where a read-modify-write operation is performed as the level of priority of the adjacent chunk area is higher than the threshold during the access extension. FIG. 10 is a diagram that illustrates a case where a read-modify-write operation is performed as the level of priority of the adjacent chunk area is higher than the threshold. A state 46 represents a state before data is written in the secondary cache 112. A state 47 represents a state after a read-modify-write operation is performed.

In this case, as illustrated in the state 46, there is an updated area 461 in the primary cache 111. The area 461 includes two sets of data, i.e., X and Y. Furthermore, a page 462 of the secondary cache 112, including the area that corresponds to the area 461, stores three sets of data, i.e., A, B, and C.

In this case, the write size is a two-logical-block size, and it has non-page alignment. Furthermore, the page 462 of the secondary cache 112, which is the write target, extends across two target areas. Furthermore, an adjacent chunk area 463 is the corresponding area that includes the logical block of the page 462, of which the data is not updated in the corresponding area of the primary cache 111, i.e., the logical block that stores the data C.

Furthermore, the entire area of the primary cache 111, which corresponds to the adjacent chunk area 463, is the area where the data is not updated, and there is a boundary match; therefore, it is determined whether a read-modify-write operation is performed in accordance with the level of priority of the adjacent chunk area 463. In this case, the level of priority of the adjacent chunk area is equal to or more than the threshold, and a read-modify-write operation is performed.

The primary-cache reading/writing control unit 106 and the secondary-cache reading/writing control unit 107 perform a read-modify-write operation by using the same method as that is explained with reference to FIG. 9. Therefore, the state is obtained as illustrated in the state 47. Specifically, the page 462 includes the data X and Y, which is the same as that in the area 461 of the primary cache 111, and the data C that is originally included. Thus, the consistency between the primary cache 111 and the secondary cache 112 is ensured, while the page 462 of the secondary cache 112 can retain the data in the logical block, for which there is no updated data in the area of the primary cache 111.

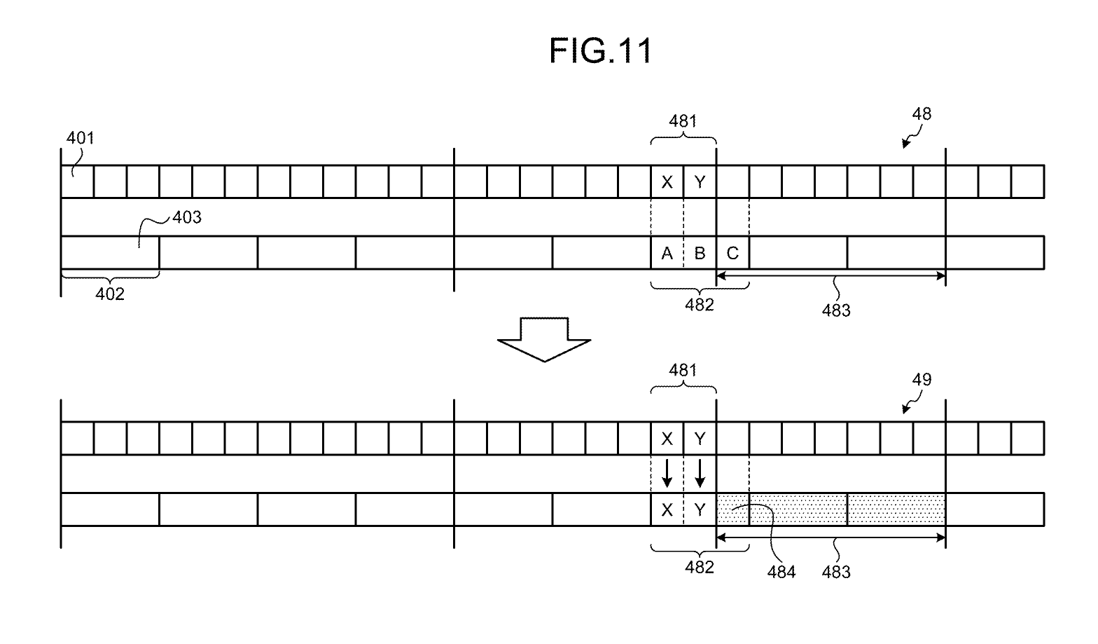

Conversely, with reference to FIG. 11, an explanation is given of data writing after the adjacent chunk area is rendered invalid during access extension. FIG. 11 is a diagram that illustrates data writing after the adjacent chunk area is rendered invalid. A state 48 represents the state before data is written in the secondary cache 112. A state 49 represents the state after data is written while the adjacent chunk area is rendered invalid.

In this case, as illustrated in the state 48, there is an updated area 481 in the primary cache 111. The area 481 includes two sets of data, i.e., X and Y. Furthermore, a page 482 of the secondary cache 112, including the area that corresponds to the area 481, stores three sets of data, i.e., A, B, and C.

In this case, the write size is a two-logical-block size, and it has non-page alignment. Furthermore, the page 482 of the secondary cache 112, which is the write target, extends across two target areas. Furthermore, an adjacent chunk area 483 is the corresponding area that includes the logical block of the page 482, of which the data is not updated in the corresponding area of the primary cache 111, i.e., the logical block that stores the data C.

Furthermore, the area of the primary cache 111, which corresponds to the adjacent chunk area 483, includes only the logical blocks where the data is not updated, that is, there is a boundary match; therefore, it is determined whether a read-modify-write operation is performed in accordance with the level of priority of the adjacent chunk area 483. In this case, the level of priority of the adjacent chunk area is less than the threshold, and data writing is conducted after the adjacent chunk area is rendered invalid.

The table managing unit 102 receives, from the overall control unit 101, a command to render the adjacent chunk area 483 invalid, and it renders the adjacent chunk area 483 invalid in the secondary-cache management table 104. The grayed-out area in the state 49 is the area that is rendered invalid. That is, it is indicated that the adjacent chunk area 483 is invalid. Then, the secondary-cache reading/writing control unit 107 writes the data, stored in the area 481, in the page 482. Here, the different data from the data C, e.g., the adjacent data of the area 481 in the primary cache 111, is written in a logical block 484, included in the page 482; however, as the adjacent chunk area 483 is invalid, the data is not referred to. Thus, the consistency between the primary cache 111 and the secondary cache 112 with regard to the newly written data is ensured. Furthermore, as wrong data is not referred to, there is no occurrence of data mismatch between the primary cache 111 and the secondary cache 112.

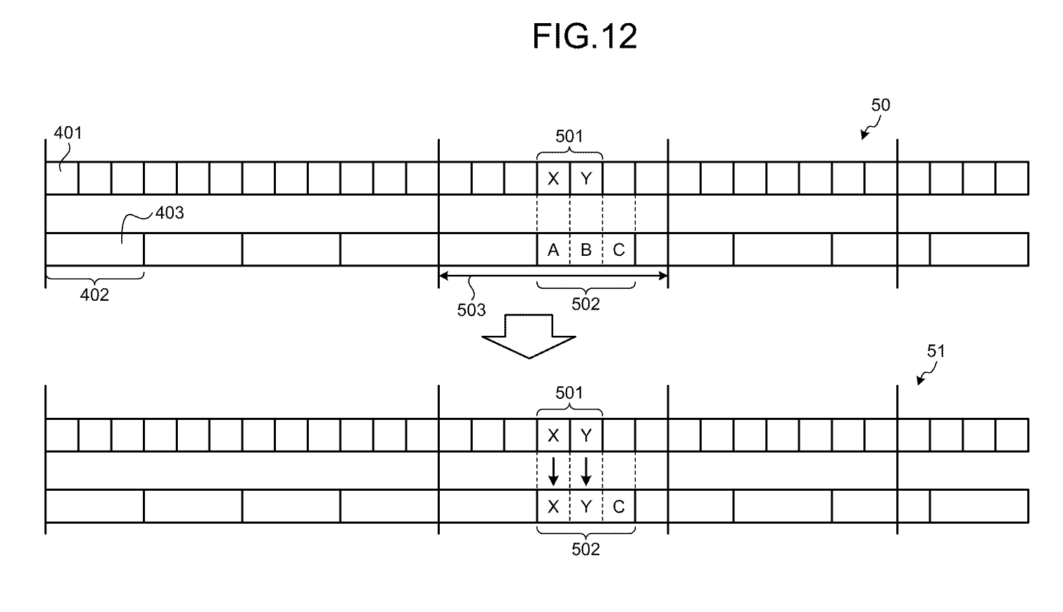

Next, with reference to FIG. 12, an explanation is given of the case of non-page alignment data writing on the page that is included in the single target area. FIG. 12 is a diagram that illustrates non-page alignment data writing on the page that is included in the single target area. A state 50 represents the state before data is written in the secondary cache 112. A state 51 represents the state after data writing is conducted.

In this case, as illustrated in the state 50, there is an updated area 501 in the primary cache 111. The area 501 includes two sets of data, i.e., X and Y. Furthermore, a page 502 of the secondary cache 112, including the area that corresponds to the area 501, stores three sets of data, i.e., A, B, and C.

In this case, the write size is a two-logical-block size, and it has non-page alignment. Furthermore, the page 502 of the secondary cache 112, which is the write target, is included in a single target area 503. In this case, a read-modify-write operation is performed.

The primary-cache reading/writing control unit 106 and the secondary-cache reading/writing control unit 107 perform a read-modify-write operation by using the same method as that is explained with reference to FIG. 9. Therefore, the state is obtained as illustrated in the state 51. Specifically, the page 502 includes the data X and Y, which is the same as that in the area 501 of the primary cache 111, and the data C that is originally included. Thus, the consistency between the primary cache 111 and the secondary cache 112 is ensured, while the page 502 of the secondary cache 112 can retain the data in the logical block, of which the data is not updated in the area of the primary cache 111.

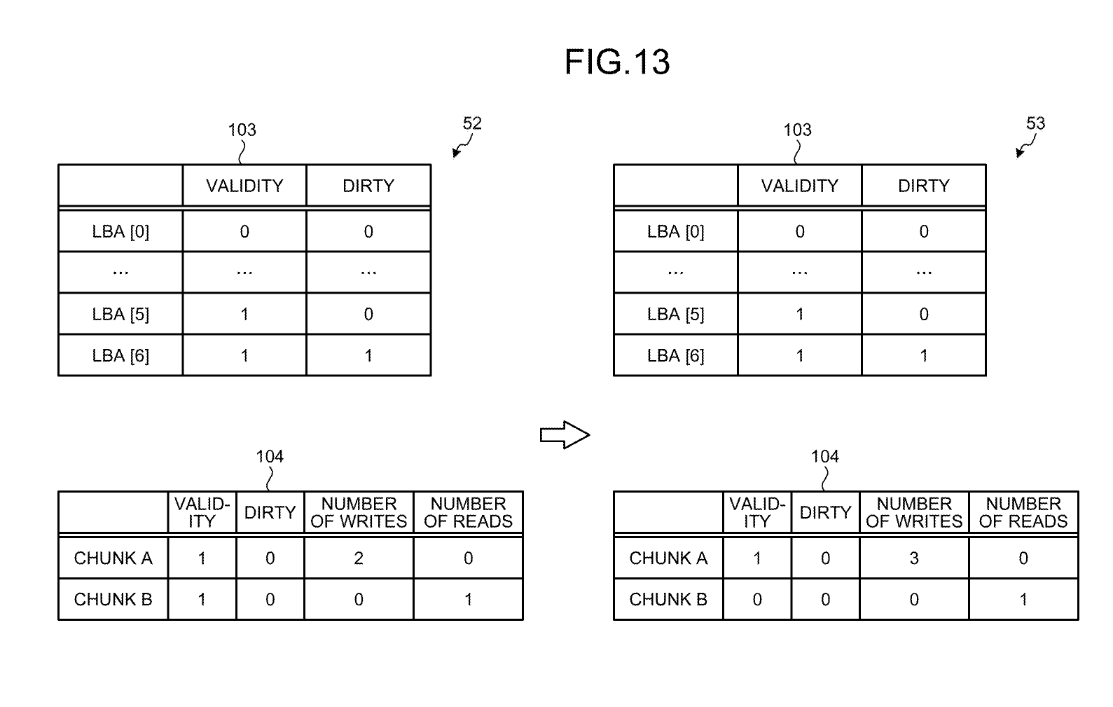

Furthermore, with reference to FIG. 13, an explanation is given of the transitions of the primary-cache management table 103 and the secondary-cache management table 104 in a case where data writing is conducted after the adjacent chunk area is rendered invalid. FIG. 13 is a table that illustrates the transitions of each of the management tables in a case where data writing is conducted after the adjacent chunk area is rendered invalid. A state 52 represents the primary-cache management table 103 and the secondary-cache management table 104 before data is written. Furthermore, a state 53 represents the primary-cache management table 103 and the secondary-cache management table 104 after data is written.

The LBA in the primary-cache management table 103 of FIG. 13 is the identification number of a logical block. Furthermore, chunks A and B in the secondary-cache management table 104 are the identification information on the corresponding chunk, indicating the corresponding area.

Here, the page, including the area that corresponds to LBA [6], extends across the two corresponding areas that have the chunk A and the chunk B as the identification information on the corresponding chunk. Furthermore, the area that corresponds to LBA [6] is included in the corresponding area that is indicated by using the chunk A. Furthermore, the corresponding area, indicated by using the chunk B, is the adjacent chunk area. Furthermore, the corresponding area, indicated by using the chunk A, and the corresponding area, indicated by using the chunk B, have a boundary match. Furthermore, an explanation is given here of a case where the level of priority of the corresponding area, indicated by using the chunk B, is less than the threshold.

In this case, the table managing unit 102 renders invalid the corresponding area that is indicated by using the chunk B in the secondary-cache management table 104. Specifically, the table managing unit 102 sets the validity flag, which is related to the chunk B, to “0”.

Furthermore, as new data is written in the area that corresponds to LBA [6], the table managing unit 102 increments the write counter by 1 for the corresponding area that is indicated by using the chunk A in the secondary-cache management table 104. Thus, the secondary-cache management table 104 enters the state that is illustrated in the state 53. Here, the secondary-cache management table 104 is changed so as to obtain the state such that the write counter is incremented; however, if a writing or reading operation is further performed on the chunk A before a predetermined time elapses, the number of reads or writes is changed.

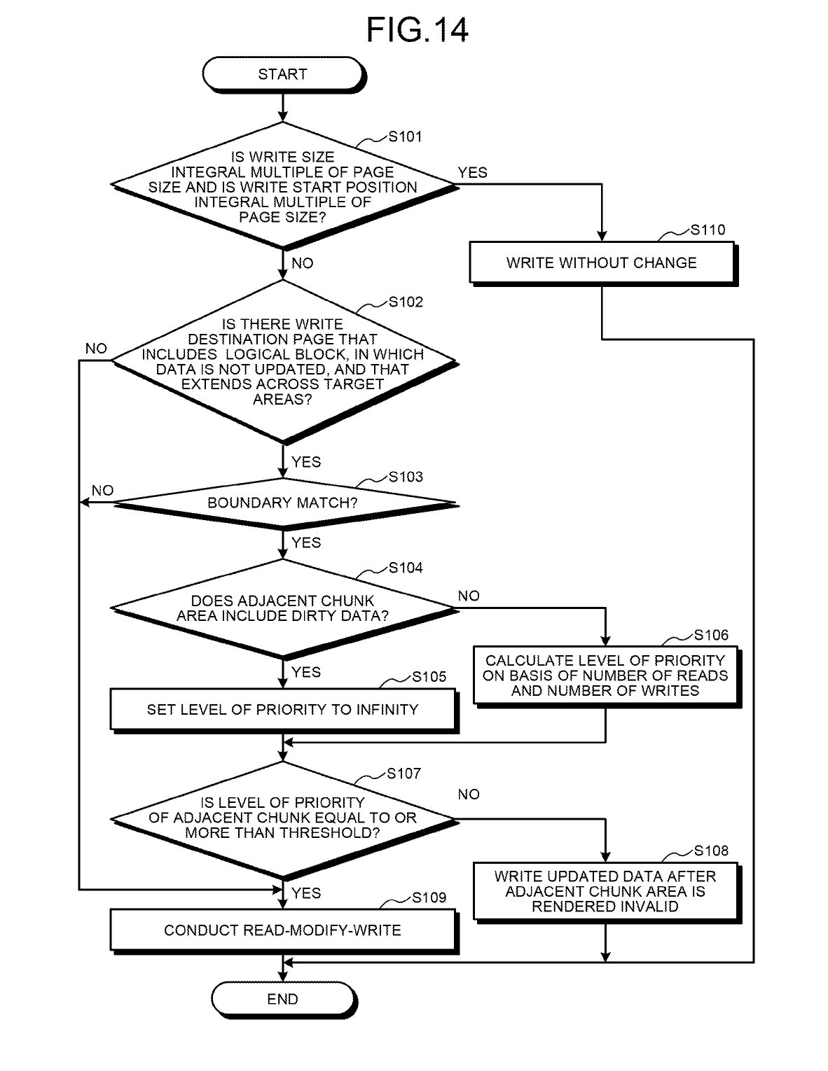

Next, with reference to FIG. 14, an explanation is given of the flow of an operation to write data during write-access extension by the storage device 1 according to the present embodiment. FIG. 14 is a flowchart of an operation to write data during write-access extension by the storage device according to the first embodiment.

If a write command, transmitted from the host 2, is hit in the primary cache 111 and the secondary cache 112 and if the secondary cache 112 is written over during the operation of write-access extension, the overall control unit 101 outputs, to the condition determining unit 108, a request to determine whether read-modify-write is conducted. In response to the request to determine whether read-modify-write is conducted, the condition determining unit 108 determines whether the write size is the integral multiple of the page size and the start position of writing in the NAND-type flash memory 30 is the integral multiple of the page size (Step S101). If the write size is the integral multiple of the page size and the start position of writing in the NAND-type flash memory 30 is the integral multiple of the page size (Step S101: yes), the condition determining unit 108 determines that it is written without change. Then, the secondary-cache reading/writing control unit 107 writes the updated data in the primary cache 111 to the correspond area of the secondary cache 112 without change (Step S110).

Conversely, if the write size is not the integral multiple of the page size or if the start position of writing in the NAND-type flash memory 30 is not the integral multiple of the page size (Step S101: no), the condition determining unit 108 determines whether there is a write destination page that includes the area that corresponds to the logical block, in which the data is not updated, and that extends across the target areas (Step S102). If there is no write destination page that includes the area that corresponds to the logical block, in which the data is not updated, and that extends across the target areas (Step S102: no), the condition determining unit 108 proceeds to Step S109.

Conversely, if there is a write destination page that includes the area that corresponds to the logical block, in which the data is not updated, and that extends across the target areas (Step S102: yes), the condition determining unit 108 determines whether there is a boundary match (Step S103). Boundary match refers to the state where the adjacent chunk area includes only the area that corresponds to the logical block, in which the data is not updated, and the target area next to the adjacent chunk area includes only the area that corresponds to the logical block, in which the data is updated. If there is no boundary match (Step S103: no), the condition determining unit 108 proceeds to Step S109.

Conversely, if there is a boundary match (Step S103: yes), the condition determining unit 108 gives a command to the priority-level calculating unit 105 to calculate the level of priority of the adjacent chunk area. The priority-level calculating unit 105 determines whether the adjacent chunk area includes dirty data (Step S104). If the adjacent chunk area includes dirty data (Step S104: yes), the priority-level calculating unit 105 sets the level of priority of the adjacent chunk area to infinity (Step S105). Then, the priority-level calculating unit 105 notifies the condition determining unit 108 of the level of priority of the adjacent chunk area.

Conversely, if the adjacent chunk area does not include dirty data (Step S104: no), the priority-level calculating unit 105 acquires the number of reads and the number of writes of the adjacent chunk area from the secondary-cache management table 104. Then, the priority-level calculating unit 105 calculates the level of priority of the adjacent chunk on the basis of the number of reads and the number of writes of the adjacent chunk area (Step S106). Then, the priority-level calculating unit 105 notifies the condition determining unit 108 of the level of priority of the adjacent chunk area.

The condition determining unit 108 acquires the level of priority of the adjacent chunk area from the priority-level calculating unit 105. Then, the condition determining unit 108 determines whether the level of priority of the adjacent chunk area is equal to or more than the threshold (Step S107). If the level of priority of the adjacent chunk area is less than the threshold (Step S107: no), the condition determining unit 108 determines that the updated data is written in the secondary cache 112 after the adjacent chunk area is rendered invalid. The table managing unit 102 receives a command to render the adjacent chunk area invalid, and it renders the adjacent chunk area invalid in the secondary-cache management table 104. Then, the secondary-cache reading/writing control unit 107 writes the updated data in the primary cache 111 to the corresponding area of the secondary cache 112 (Step S108).

Conversely, if the level of priority of the adjacent chunk area is equal to or more than the threshold (Step S107: yes), the condition determining unit 108 determines that read-modify-write is conducted. Then, the primary-cache reading/writing control unit 106 and the secondary-cache reading/writing control unit 107 use the read-modify-write buffer 113 to conduct read-modify-write (Step S109).

As described above, during non-page alignment data update, the storage device according to the present embodiment determines whether a read-modify-write operation is performed in accordance with the state of the updated data. In this way, read-modify-write is selectively conducted; thus, the number of accesses to a secondary cache, such as a NAND-type flash memory, may be reduced, and the throughput may be improved.

Furthermore, as read-modify-write is correctly conducted, the hit rate may be ensured. Therefore, it is possible that, while the throughput is improved, the hit rate is ensured, and the system performance is improved.

### [b] Second Embodiment

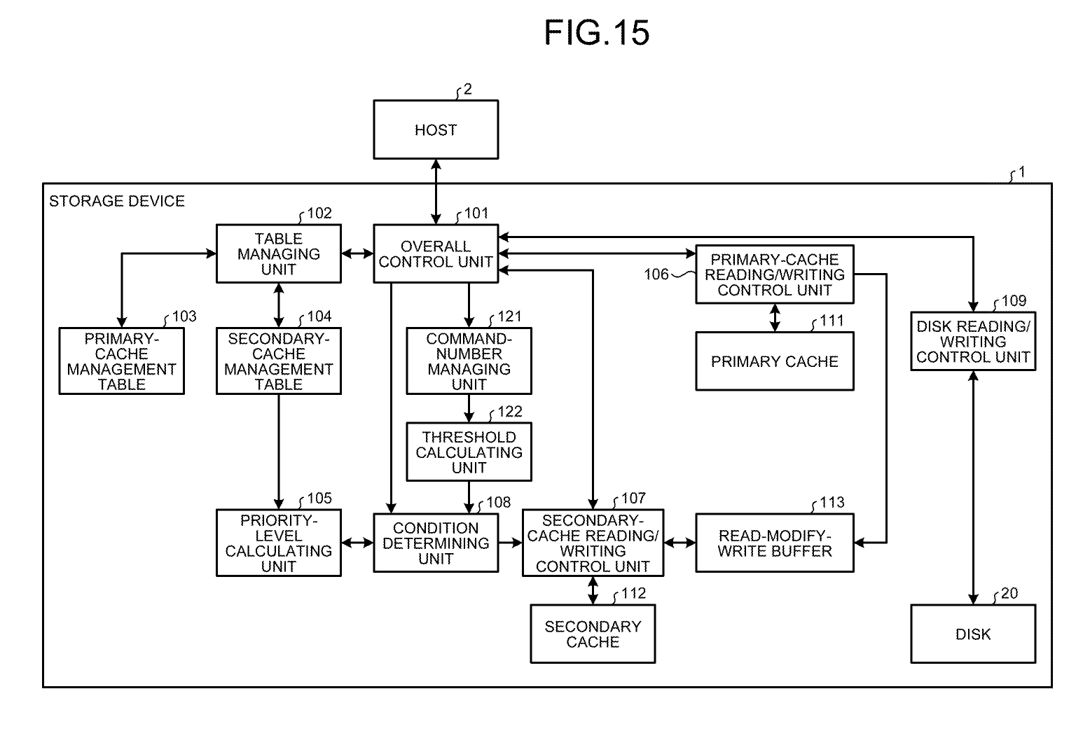

FIG. 15 is a block diagram of the storage device according to a second embodiment. The storage device 1 according to the present embodiment is different from that of the first embodiment in that the threshold for the level of priority of the adjacent chunk area, used for determination as to whether a read-modify-write operation is performed, is changed in accordance with the state of access to the secondary cache 112. In the following explanations, an explanation is omitted for the function of each unit, which is the same as that in the first embodiment.

The storage device 1 according to the present embodiment includes a command-number managing unit 121 and a threshold calculating unit 122 in addition to the units in the first embodiment.

The overall control unit 101 also outputs, to the command-number managing unit 121, a read command and a write command that are output to the secondary-cache reading/writing control unit 107. Furthermore, if the secondary-cache reading/writing control unit 107 terminates the operations that are designated by using the read command and the write command, the overall control unit 101 notifies the command-number managing unit 121 of completion of the terminated read command and write command.

Furthermore, if the overall control unit 101 outputs, to the condition determining unit 108, a request to determine whether read-modify-write is conducted, it outputs, to the command-number managing unit 121, a command to transmit the number of commands together with the information on the adjacent chunk area.

The command-number managing unit 121 includes, for each read command and each write command, the counter that counts a read command and a write command that are being issued to the secondary-cache reading/writing control unit 107. Hereafter, each counter is referred to as the “read counter” and the “write counter”.

The command-number managing unit 121 receives, from the overall control unit 101, inputs of the read command and the write command that are output to the secondary-cache reading/writing control unit 107. If a read command is received, the command-number managing unit 121 increments the read counter by 1. Furthermore, if a write command is received, the command-number managing unit 121 increments the write counter by 1.

Furthermore, the command-number managing unit 121 receives, from the overall control unit 101, inputs of the completion notification of the read command and the completion notification of the write command, output to the secondary-cache reading/writing control unit 107. If the completion notification of the read command is received, the command-number managing unit 121 decrements the read counter by 1. Furthermore, if the completion notification of the write command is received, the command-number managing unit 121 decrements the write counter by 1.

In this way, the command-number managing unit 121 counts the numbers of issued read commands and write commands and reduces the number of completed read commands and write commands from the counted numbers. Thus, the command-number managing unit 121 is capable of determining the numbers of read commands and write commands that are being issued to the secondary-cache reading/writing control unit 107 at that time, i.e., the number of accesses to the secondary cache 112.

Furthermore, the command-number managing unit 121 receives, from the overall control unit 101, an input of a command to transmit the number of commands. Then, the command-number managing unit 121 outputs the numbers of the read counter and the write counter to the threshold calculating unit 122. Hereafter, the number of read counters, output by the command-number managing unit 121, is referred to as the read command number. Furthermore, the number of write counters, output by the command-number managing unit 121, is referred to as the write command number. The command-number managing unit 121 is an example of a “command-number managing unit”.

The threshold calculating unit 122 has the information on the read coefficient and the write coefficient that are the coefficients based on the loads of each read command and each write command to the NAND-type flash memory 30. Here, according to the present embodiment, the value of the ratio between the reading response performance and the writing response performance of the NAND-type flash memory 30 is used as an example of the read coefficient and the write coefficient. Furthermore, the threshold calculating unit 122 has the information on the maximum number of commands that may be handled by the NAND-type flash memory 30. Furthermore, the threshold calculating unit 122 has the information on the constant of the threshold, which is the reference for calculating the threshold. Here, according to the present embodiment, an explanation is given of a case where the threshold, calculated according to the first embodiment, is used as the constant of the threshold.

The threshold calculating unit 122 receives, from the command-number managing unit 121, inputs of the read command number and the write command number when the condition determining unit 108 determines whether a read-modify-write operation is performed. Then, the threshold calculating unit 122 adds the multiplied value of the read command number and the read coefficient to the multiplied value of the write command number and the write coefficient. Next, the threshold calculating unit 122 divides the addition result by the multiplied value of the write coefficient and the maximum command number. Then, the threshold calculating unit 122 multiplies the division result by the constant of the threshold so as to calculate the threshold. Afterward, the threshold calculating unit 122 outputs the calculated threshold to the condition determining unit 108.

Here, the constant of the threshold is Cₜₕ, the read coefficient is a, the write coefficient is b, the maximum command number is cmdmax, the read command number at time t is r(t), and the write command number at the time t is w(t). Furthermore, the calculated threshold at the time t is TH(t). In this case, the threshold calculating unit 122 is capable of calculating the threshold by using the equation of TH(t)={a×r(t)+b×w(t)}/(b×cmdmax).

The threshold that is calculated by the threshold calculating unit 122 becomes higher if the number of commands being issued is large, and a read-modify-write operation is unlikely to be performed. Conversely, the threshold that is calculated by the threshold calculating unit 122 becomes lower if the number of commands being issued is small, and a read-modify-write operation is likely to be performed. Furthermore, depending on the values of the read coefficient and the write coefficient, the threshold becomes different in a case where the ratio of the read command is high and in a case where the ratio of the write command is high, even if the number of commands being issued is the same. Specifically, as the response performance of a write operation is lower than that of a read operation, the threshold calculating unit 122 calculates the threshold such that the threshold becomes higher if the ratio of the write command is higher and the threshold becomes lower if the ratio of the read command is higher. That is, if the number of issued write commands, of which the response performance is low, is large, the threshold calculating unit 122 determines that the NAND-type flash memory 30 is in a busy state, and it increases the threshold so as to suppress a read-modify-write operation.

Furthermore, if the write commands in the maximum command number are being issued to the NAND-type flash memory 30, the threshold that is calculated by the threshold calculating unit 122 is the highest, i.e., it matches the constant of the threshold. Furthermore, if no commands are issued to the NAND-type flash memory 30, the threshold that is calculated by the threshold calculating unit 122 is set to 0.

As described above, the threshold calculating unit 122 applies the number of commands, being issued to the NAND-type flash memory 30, to the threshold. Thus, if there are accesses centered in the NAND-type flash memory 30, the storage device 1 refrains from read-modify-write operations, whereby the throughput of the NAND-type flash memory 30 is ensured. Furthermore, if the NAND-type flash memory 30 is available, the storage device 1 increases execution of read-modify-write operations, whereby data in the secondary cache 112 is retained so that the hit rate is ensured. In this way, as the threshold calculating unit 122 dynamically changes the threshold, it is possible to perform a control by keeping a balance between the throughput and the hit rate.

The condition determining unit 108 receives, from the overall control unit 101, an input of a request to determine whether a read-modify-write operation is performed. Furthermore, the condition determining unit 108 receives an input of the threshold from the threshold calculating unit 122. Then, the condition determining unit 108 uses the threshold, acquired from the threshold calculating unit 122, to determine whether read-modify-write is conducted.

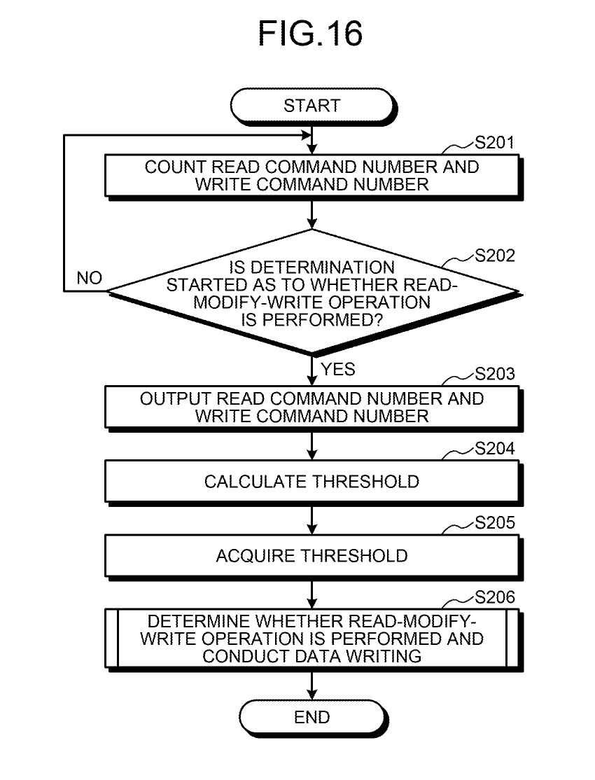

Next, with reference to FIG. 16, an explanation is given of the flow of an operation to determine whether a read-modify-write operation is performed by the storage device 1 according to the present embodiment. FIG. 16 is a flowchart of an operation to write data during write-access extension by the storage device according to the second embodiment.

The command-number managing unit 121 uses the self-owned counter to count the read command number and the write command number, i.e., the number of read commands and the number of write commands, being issued to the secondary-cache reading/writing control unit 107 (Step S201).

Due to the notification from the overall control unit 101, the command-number managing unit 121 determines whether a determination is started as to whether a read-modify-write operation is performed (Step S202). If the determination is not started (Step S202: no), the command-number managing unit 121 returns to Step S201.

If the determination is started (Step S202: yes), the command-number managing unit 121 outputs the read command number and the write command number to the threshold calculating unit 122 (Step S203).

The threshold calculating unit 122 acquires the read command number and the write command number from the command-number managing unit 121. Then, the threshold calculating unit 122 uses the constant of the threshold, the read coefficient, the write coefficient, the maximum command number, the read command number, and the write command number to calculate the threshold (Step S204). Then, the threshold calculating unit 122 outputs the calculated threshold to the condition determining unit 108.

The condition determining unit 108 acquires, from the threshold calculating unit 122, the threshold to be used for determination (Step S205).

Then, the condition determining unit 108 uses the acquired threshold to determine whether a read-modify-write operation is performed. Then, in accordance with a determination result by the condition determining unit 108, the secondary-cache reading/writing control unit 107 writes data in the secondary cache 112 (Step S206). Here, the operation that is performed at Step S206 is, for example, the operation that is illustrated in FIG. 14.

As described above, the storage device according to the present embodiment adjusts the frequency of execution of read-modify-write in accordance with the state of access to the secondary cache. Thus, it is possible to keep a balance between maintenance of the throughput of the secondary cache and retention of data in the secondary cache more appropriately.

Here, in the above explanations of each embodiment, the size of chunk of the primary cache is used as a unit for management of the secondary cache; however, this is not a limitation on the management unit. For example, the management unit may be a unit of logical block or a unit of chunk of the secondary cache. As the management unit becomes smaller, it is possible to appropriately determine whether the management unit area is rendered invalid.

Furthermore, the program for implementing each of the above-described embodiments does not need to be initially stored in the disk 20. For example, the program is stored in a “portable physical medium”, such as a flexible disk (FD), compact disc read only memory (CD-ROM), digital versatile disk (DVD), magnet-optical disk, or IC card, which is inserted into the host 2. Then, the host 2 reads the program from the above and transmits it to the storage device 1 so that it may be executed.

Furthermore, the program is stored in a “different computer (or server)” that is connected to the host 2 via a public network, the Internet, LAN, WAN, or the like. Then, the host 2 reads the program from the above and transmits it to the storage device 1 so that it may be executed.

According to an aspect of a storage device, a cache-write control method, and a cache-write control program, disclosed in the subject application, there are advantages such that, while the throughput is improved, the hit rate may be ensured and the system performance may be improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device comprising:
a cache, in which one-time data writing is conducted on each write unit area, and written data is managed for each management unit area;
a determining unit that, when write data is written in part of a specific write unit area of the cache, determines whether the specific write unit area extends across the management unit areas of the cache and, when the specific write unit area extends across the management unit areas, determines whether already stored data in an unupdated area is to be retained based on a use condition of the management unit area that includes the unupdated area, in which the write data is not written, in the specific write unit area; and
a writing unit that, when the determining unit determines that the already stored data is to be retained, writes the write data in the specific management unit area while the already stored data is retained.

2. The storage device according to claim 1, wherein, when the determining unit determines that data in the unupdated area is not to be retained, the writing unit rendered invalid the management unit area, including the unupdated area, and writes the write data.

3. The storage device according to claim 1, further comprising a temporary storage unit, wherein the writing unit stores the write data in the temporary storage unit, stores the already stored data in the temporary storage unit, merges the write data and the already stored data in the temporary storage unit to generate merged data, and writes the merged data in the specific write unit area.

4. The storage device according to claim 1, wherein the determining unit calculates a level of priority of the management unit area, including the unupdated area, in accordance with the use condition and determines that the already stored data in the unupdated area is to be retained when the level of priority exceeds a threshold.

5. The storage device according to claim 4, further comprising:
a command-number managing unit that counts a number of write commands and read commands that are being issued to the cache; and
a threshold calculating unit that calculates the threshold in accordance with a count result of the command-number managing unit, wherein
the determining unit makes a determination by using the threshold that is calculated by the threshold calculating unit.

6. A cache-write control method comprising:
when write data is written in part of a specific write unit area of a cache, in which one-time data writing is conducted on each write unit area and written data is managed for each management unit area, determining whether the specific write unit area extends across management unit areas of the cache;
when the specific write unit area extends across the management unit areas, determining whether already stored data in an unupdated area is to be retained based on a use condition of the management unit area that includes the unupdated area, in which the write data is not written, in the specific write unit area; and
when it is determined that the already stored data is to be retained, writing the write data in the specific management unit area while the already stored data is retained.

7. A computer-readable recording medium having stored therein a program that causes a computer to execute a process comprising:
when write data is written in part of a specific write unit area of a cache, in which one-time data writing is conducted on each write unit area and written data is managed for each management unit area, determining whether the specific write unit area extends across management unit areas of the cache;
when the specific write unit area extends across the management unit areas, determining whether already stored data in an unupdated area is to be retained based on a use condition of the management unit area that includes the unupdated area, in which the write data is not written, in the specific write unit area; and
when it is determined that the already stored data is to be retained, writing the write data in the specific management unit area while the already stored data is retained.
